(19) United States
(12) Patent Application Publication
(10) Pub. No.: US 2023/0083151 A1
(43) Pub. Date: Mar. 16, 2023

(54) BREWING MODULE AND BREWING METHOD THEREOF

(71) Applicant: LIAN FA INTERNATIONAL DINING BUSINESS CORPORATION, TAIPEI CITY (TW)

(72) Inventor: KAI-LUNG CHENG, TAIPEI CITY (TW)

(21) Appl. No.: 17/558,993

(22) Filed: Dec. 22, 2021

Related U.S. Application Data
(60) Provisional application No. 63/243,366, filed on Sep. 13, 2021.

(51) Int. Cl. A47J 31/44; A47J 31/52

(52) U.S. Cl. CPC A47J 31/4492; A47J 31/5253

(57) ABSTRACT

Disclosed are a brewing module and its brewing method. The brewing module is combined with a smart brewing machine for use and includes a brewing control module with an inductive identification unit, and a brewing material package unit with a package and an identification member, and the package contains a brewing material, and the identification member is installed onto the package. The inductive identification unit is used for sensing, recognizing and reading the identification member, and the identification member contains information of the brewing material and information and brewing execution information of the brewing material. In this way, the source of brewing material required for the production of a brewed beverage can be ensured, and errors easily caused by human operations can be avoided, so that the quality of the brewed beverage can be consistent.

### FIELD OF THE INVENTION

The present invention relates to a brewing module, and more particularly to the brewing module having an inductive identification unit and an identification member and its brewing method.

### BACKGROUND OF THE INVENTION

### 1. Description of the Related Art

People nowadays are often keen on various beverages such as tea, coffee, and different brewed drink. In order to conveniently and quickly make a drink, various automatic brewing machines such as smart tea maker, smart coffee maker, etc. are produced. As to the smart tea makers, there are family-size, individual small and medium-sized smart tea maker, or large commercial smart tea maker in response to the hand shake beverage industry, which are very popular in the market. Most of these smart tea makers provide an operating panel for users to press to perform their automatic smart tea making operation.

Due to the large variety of teas, and various factors such as the place of origin, season, and production method of the tea, it is difficult for users to control and make good tea by the smart tea maker, and thus having the drawback of making tea with unstable quality. As to the large commercial smart tea makers, a wrong or different operation of the operator will also cause an unable quality of the tea. In summary, the conventional smart tea makers often have the following drawbacks:

(1) The tea material source required for manufacturing a certain tea product is inconsistent, so that the quality of the tea product is also inconsistent.

(2) In the production of a certain type of tea products by manual pressing operations, the type and quantity of the tea material may sometimes be wrong or mistaken in busy time, so that the tea quality will be inconsistent.

(3) In the production of a certain type of tea products by manual pressing operations, the operating procedure and the control of detailed conditions may be wrong or mistaken in busy time, so that the quality of the tea quality will be inconsistent.

In view of the aforementioned drawbacks and the structural design issues of the conventional smart brewing machines, the inventor of the present invention based on years of experience to conduct research and experiment, hoping to develop a more convenient and quality-stable brewing module and its brewing method, in order to overcome the drawbacks of the prior art.

### 2. Summary of the Invention

Therefore, it is a primary objective of the present invention to provide a guaranteed source of brewing material required for producing a certain type of brewed beverage, so that the brewed beverage has a consistent quality.

Another objective of the present invention is to precisely control the quantity of the brewing material and related operation of the brewed beverage, so as to avoid the error, negligence or inconsistency of human operations, and ensure the quality and consistency of the brewed beverage.

A further objective of the present invention is to provide a unique identification member marked on each material package and start the procedure of producing the brewed beverage by the brewing machine after an inductive identification unit of the brewing machine has checked the identification member marked on the material package and confirmed that the identification member is qualified.

Another objective of the present invention is to set a limit of times (which can be changed) for each sensed (scanned) qualified identification member to start the production procedure of the brewing machine, so as to improve the controllability or flexible range of the application.

To achieve the aforementioned and other objectives, the present invention discloses a brewing module, combined with a smart brewing machine for use, and the brewing module comprises: a brewing control module, having an inductive identification unit installed therein; and a brewing material package unit, comprising a package and identification member, and the package containing a brewing material, and the identification member being disposed on the package, and the inductive identification unit being provided for sensing, recognizing and reading the identification member, and the identification member having information of the brewing material and brewing execution information of the brewing material.

In this embodiment, the identification member of each package has the identification member of a unique identity certification, or the package of the same type of brewing material has the same dedicated identification member, so that the inductive identification unit can check and control the identification member to confirm the source of the brewing material.

In this embodiment, the identification member has a check code, and a check control element of the production company name.

In this embodiment, the brewing execution information comprises brewing control instruction, brewing and manufacturing condition, brewing temperature, amount of water, time, rotation speed, cooling, and operation process.

In this embodiment, the identification member is a QR code.

In this embodiment, the brewing control module is combined with the smart brewing machine to form a smart brewing device.

In this embodiment, the brewing material is one selected from the group of tea, coffee, fruit juice, herbal tea, milk tea, and fruit tea with fruit granules.

In this embodiment, the smart brewing machine comprises a brewing machine control unit telecommunicatively coupled to the inductive identification unit, and the telecommunicative connection comprises an electrical connection or a connection cable and wireless signal transmission, and the brewing machine control unit is provided for controlling the smart brewing machine to perform a brewing operation of the brewing execution information.

In this embodiment, the smart brewing machine has a brewing part with an opening for putting in the brewing material.

In this embodiment, the brewing control module is coupled to a network device for sending the information read by the identification member to a database through the network device.

In this embodiment, the network device is used for a cable or wireless network transmission, the database is disposed in a server or a cloud server.

In this embodiment, the brewing control module checks the identification member on the package, and after the identification member is checked and confirmed to be a qualified identification member, the smart brewing machine will start the brewing operation of the brewing execution information, and each qualified identification member has a limit of times of starting the smart brewing machine to perform the brewing operation.

To achieve the aforementioned and other objectives, the present invention further discloses a brewing method of the brewing module, and the method comprises: obtaining a brewing material package unit; sensing the brewing material package unit and a brewing control module; obtaining related brewing information from the brewing material package unit by the brewing control module; and sending the brewing information to a brewing machine control unit of a smart brewing machine via cable or wireless transmission by the brewing control module.

In the brewing method of this embodiment, the brewing material package unit comprises a package and an identification member, and the package contains a brewing material, and after the brewing material is put into the smart brewing machine, the brewing machine control unit starts the brewing operation of the smart brewing machine.

The brewing method of this embodiment further comprises: sending a part of the whole of the brewing information to a database via a cable or wireless transmission of a network device by the brewing control module.

The brewing method of this embodiment further comprises: performing a statistical operation to analyze and summarize a part or the whole of the brewing information of the database and obtain brewing statistical information.

The brewing method of this embodiment further comprises: including the brewing statistical information into a big data operation and application.

### BRIEF DESCRIPTION OF THE DRAWINGS

FIG. 1 is an exploded view of the present invention;

FIG. 2 is a schematic view showing the induction operation of the present invention;

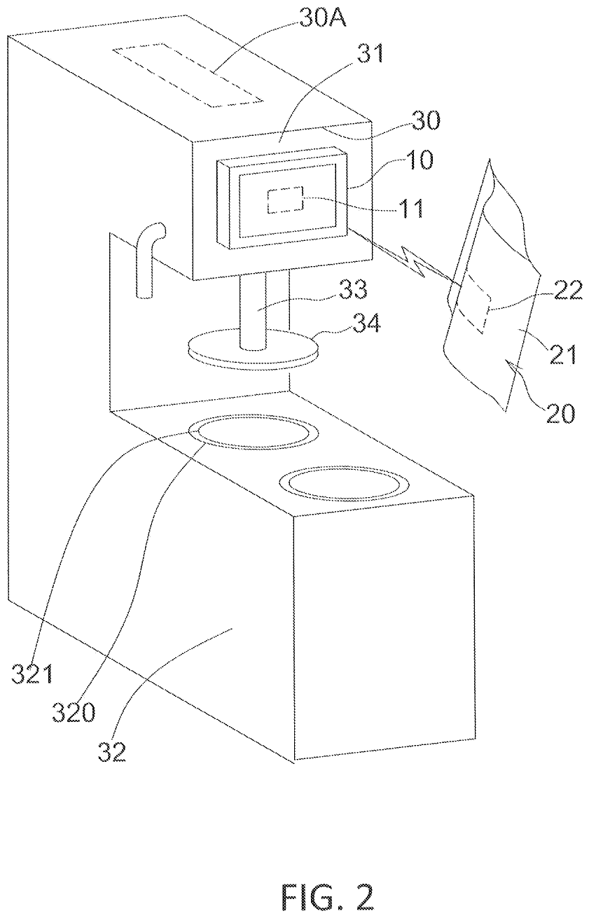

FIG. 3 is a schematic view showing the brewing operation of the present invention; and

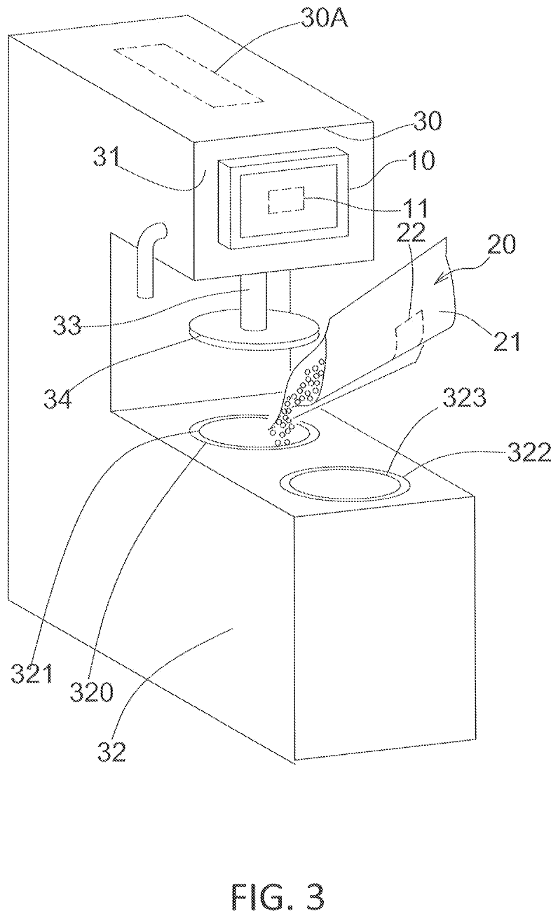

FIG. 4 is a flow chart of the method of the present invention.

### DESCRIPTION OF THE PREFERRED EMBODIMENTS

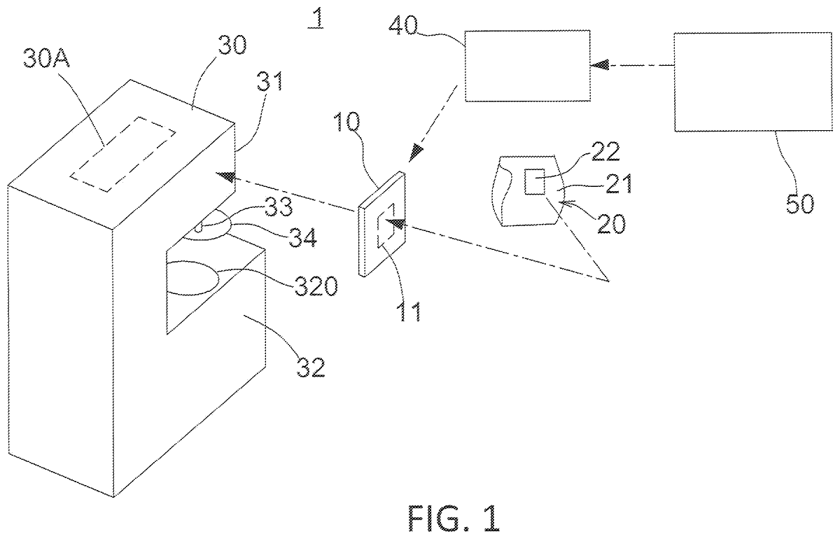

With reference to FIG. 1 for a brewing module in accordance with the present invention, the brewing module comprises a brewing control module 10 and a brewing material package unit 20, and an inductive identification unit 11 is installed in the brewing control module 10 for sensing, recognizing and reading related information of the brewing material package unit 20, and the brewing control module 10 is combined and used with a smart brewing machine 30 to form a smart brewing machine device 1, and the combination of the brewing control module 10 and the smart brewing machine 30 includes a mechanical connection, an electrical connection or a telecommunicative connection.

The brewing material package unit 20 comprises a package 21 and an identification member 22, and the package 21 includes but not limited to a bag, a box or a capsule, etc. The package 21 contains a brewing material, such as tea, coffee or other brewing/drinking materials (including various fruit juices, herbal teas, milk teas, fruit teas with various fruit granules or fruit puree, etc.); the identification member 22 is installed on the package 21. In an embodiment, the identification member is an identification code such as a Quick Response Code (QR code) or any other object used for identification. The identification member 22 has related information of the brewing material and brewing execution information of the brewing material. The brewing execution information comprises a brewing control instruction and brewing and manufacturing conditions, such as related brewing temperature, amount of water, time, rotation speed, cooling, operation process, and other control conditions. When the inductive identification unit 11 (or the brewing control module 10) has read the identification member 22, the content of information of the identification member 22 can be confirmed before carrying out the subsequent operating procedure. Each type of the brewing materials adopts its dedicated identification member 22 which is used to control the brewing and manufacturing procedure and conditions of the smart brewing machine 30, so as to maintain a consistent quality of a brewed beverage (such as a tea drink) produced by the same brewing material.

The smart brewing machine 30 comprises a brewing machine control unit 30A for controlling related brewing operations of the smart brewing machine 30, and the brewing machine control unit 30A is telecommunicatively coupled to the inductive identification unit 11 (or the brewing control module 10) by an electrical connection to or a connection via a cable and wireless signal transmission, so that the smart brewing machine 30 can carry out the preform the brewing operation corresponding to the brewing execution information by the information of the inductive identification unit 11 received by the brewing machine control unit 30A. The smart brewing machine 30 comprises a wall 31, so that the brewing control module 10 can be installed or embedded into the wall 31 (or the smart brewing machine 30). In other words, the brewing control module 10 can be combined with the smart brewing machine 30 (or the wall 31) to constitute an electrical connection or a connection via signal, or the brewing control module 10 and the smart brewing machine 30 are separated, but they are still electrically connected or connected via signal.

The smart brewing machine 30 has a brewing part 32 configured with a brewing space, and the brewing part 32 has an opening 320, and a brewing container 321 is disposed in the opening 320, wherein the brewing container 321 can be a bucket, a bottle or a cup used for putting in a brewing material contained in the package 21 to perform the brewing operation and facilitate the removal of the brewing container 321 for cleaning and maintenance. The smart brewing machine 30 has an injection pipe 33 and a cover 34, and the injection pipe 33 is provided for adding an adjustable amount of water, and the cover 34 is provided for covering the opening 320 during the brewing operation. Of course, the brewing part 32 of an embodiment can be combined with other apparatus as shown in the figure, and the brewing part 32 also has an opening 322 provided for installing a spare brewing container 323, wherein the spare brewing container 323 is a bucket, a bottle or a cup, so that after the brewed beverage contained in the brewing container 321 can be poured or guided into the spare brewing container 323 for cooling or waiting to be consumed, and the spare brewing container 323 also can be removed for cleaning and maintenance.

In the embodiment above, the smart brewing machine 30 is a large commercial smart tea maker commonly used in the hand shake beverage industry. It is noteworthy that the family-sized or personal small and medium sized smart tea makers also can achieve the same automatic brewing operation effect by reading information.

The brewing control module 10 can be connected to a network device 40 and the information of the identification member 22 can be sent to a database 50 by the network device 40, wherein the network device 40 is provided for a cable or wireless network transmission, and the database 50 is installed in a server or a cloud server.

When the brewing module of the present invention is used, the brewing control module 10 of the smart brewing machine 30 senses the identification member 22 (such as the QR code) on the package 21 to read the related information such as the control procedure and condition of the brewing material contained in the brewing material package unit 20, and the brewing material in the package 21 is put into the brewing container 321 of the brewing part 32 through the opening 320 for the brewing operation.

In the present invention, the brewing control module 10 will check the identification member 22 (such as the QR code) on the package 21. After the identification member 22 is checked and confirmed to be a qualified identification code, the smart brewing machine 30 will start the production procedure of the brewed beverage. If the identification member 22 (such as the QR code) cannot be read or is not qualified, it means that the brewing material is not a product that is controlled by the smart brewing machine 30, so that the production procedure of the brewed beverage will not started.

In the present invention, the material source is controlled, and the identification member 22 (such as the QR code) marked on the package 21 contains the information of the source of the brewing material, and the inductive identification unit 11 of the present invention will set a qualified source of brewing material in advance and use this identification member 22 for the comparison with the information of the source of the brewing material. If the source complies with the set qualified source of brewing material, the identification member 22 will be considered as a qualified identification member 22. After the identification member 22 is checked, compared and confirmed as a qualified identification member 22, the smart brewing machine 30 will start the production procedure of the brewed beverage.

In each time of checking the identification member 22 (such as the QR code) on the package 21, the current related data will be sent to a server, so that recommendations on the supply and sales of the products can be provided by computing the related data of the usage of the package 21 in order to improve the management performance.

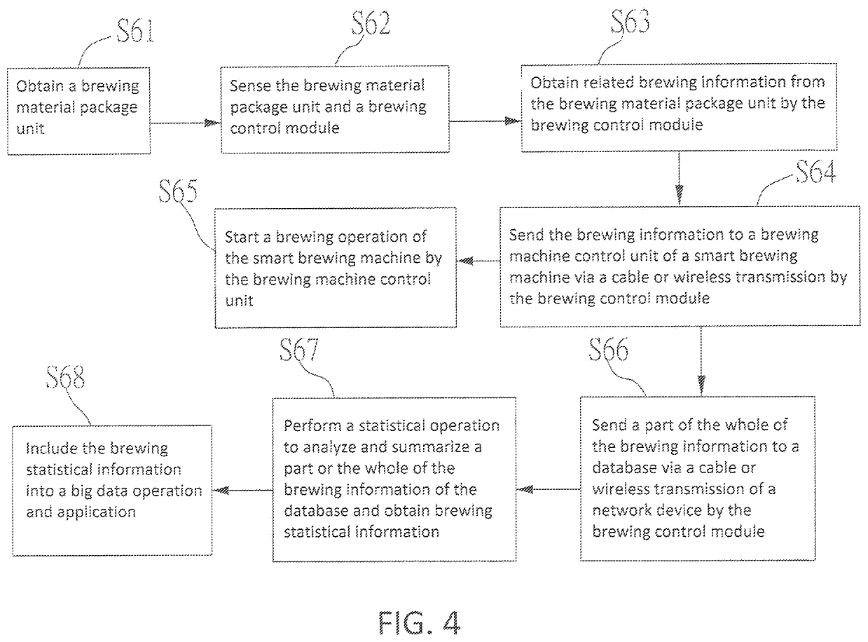

With reference to FIG. 4 for a brewing method of the brewing module in accordance with the present invention, the brewing method for a qualified normal operation comprises the following steps:

(1) S61: Obtain a brewing material package unit (which is the brewing material package unit 20);

(2) S62: Sense the brewing material package unit and a brewing control module (which are the brewing material package unit 20 and the brewing control module 10);

(3) S63: Obtain the related brewing information contained in the brewing material package unit by the brewing control module (i.e. the brewing control module 10 obtains the related brewing information contained in the identification member of the brewing material package unit 20);

(4) S64: Send the brewing information to a brewing machine control unit of a smart brewing machine via a cable or wireless transmission by the brewing control module (i.e. the brewing control module 10 sends the brewing information (which is the brewing execution information) to a brewing machine control unit 30A of a smart brewing machine 30 via a cable or wireless transmission.

In the steps (1) to (4) of the aforementioned procedure, the brewing material contained in the package 21 is put into the brewing container 321 in an appropriate time to carry out the brewing operation.

S65: Start the brewing operation of the smart brewing machine by the brewing machine control unit (i.e. the brewing machine control unit 30A starts the brewing operation of the smart brewing machine 30, and makes the smart brewing machine 30 to execute the brewing operation procedure received by the brewing machine control unit 30A.

The step (4) further comprises the following steps:

(6) S66: Send a part or the whole of the brewing information to a database via a cable or wireless transmission of a network device by the brewing control module (i.e. the brewing control module 10 sends a part or the whole of the brewing information to a database 50 via a cable or wireless transmission of a network device 40.

(7) S67: Perform a statistical operation to analyze and summarize a part or the whole of the brewing information in the database and obtain brewing statistical information (i.e. A statistical operation to analyze and summarize a part or the whole of the brewing information in the database 50 and obtains brewing statistical information.

(8) S68: Include the brewing statistical information into a big data operation and application (i.e. The brewing statistical information is included into a big data operation and application, and the information of the big data can be used to generate a consumer trend in order to commend the order quantity for the next quarter.

When the brewing module and its brewing method of the present invention are used for producing tea beverage, the technical characteristics of the brewing module provide the following functions and effects:

(1) The tea source required for producing a certain tea beverage can be guaranteed to maintain a consistent quality of the tea beverage.

(2) The quantity of tea materials and related brewing operation of the tea beverage can be controlled to avoid the error, negligence or inconsistency of human operations, and ensure the quality and consistency of the brewed beverage.

(3) The identification member (or QR code) on each material bag is a unique identification code. In other words, each material bag has its own identity code. Any unqualified identification member 22 indicates that the brewing material package unit 20 is a controlled material of the present invention. In this way, the present invention has a control of the material source. Further, the identification member 22 of the brewing material package unit 20 contains information of the material source, and the present invention presets a qualified material source, and only the identification member 22 of the brewing material package unit 20 having the information of a qualified material source can be considered as a qualified identification member 22. Elements including but not limited to a check code or a production company name can be used for the control.

(4) The inductive identification unit (or the brewing control module) of this invention will check the identification member on the package 21. After the identification member 22 is checked and confirmed to be qualified, the smart brewing machine will start the production procedure of the brewed beverage.

(5) A limit of times can be preset for each checked and qualified identification member 22 to start the production procedure of the brewing machine, so as to improve the flexible range of the application and avoid the inconsistent product quality caused by using a material with an identification member 22 which is not specified for the production.

While the invention has been described by way of examples and in terms of preferred embodiments, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures. It is noteworthy that the embodiments and figures disclosed herein are to be considered illustrative rather than restrictive.

What is claimed is:

1. A brewing module, combined with a smart brewing machine for use, comprising:
a brewing control module, having an inductive identification unit installed therein; and
a brewing material package unit, comprising a package and identification member, and the package containing a brewing material, and the identification member being disposed on the package, and the inductive identification unit being provided for sensing, recognizing and reading the identification member, and the identification member having information of the brewing material and brewing execution information of the brewing material.

2. The brewing module according to claim 1, wherein the identification member of each package has the identification member of a unique identity certification, or the package of the same type of brewing material has the same dedicated identification member, so that the inductive identification unit can check and control the identification member to confirm the source of the brewing material.

3. The brewing module according to claim 1, wherein the brewing execution information comprises a brewing control instruction, a brewing and manufacturing condition, a brewing temperature, amount of water, time, a rotation speed, cooling, and an operation process.

4. The brewing module according to claim 2, wherein the identification member is a QR code.

5. The brewing module according to claim 2, wherein the brewing control module is combined with the smart brewing machine to form a smart brewing device.

6. The brewing module according to claim 5, wherein the smart brewing machine comprises a brewing machine control unit telecommunicatively coupled to the inductive identification unit, and the telecommunicative connection comprises an electrical connection or a connection cable and wireless signal transmission, and the brewing machine control unit is provided for controlling the smart brewing machine to perform a brewing operation of the brewing execution information.

7. The brewing module according to claim 2, wherein the brewing control module is coupled to a network device, for sending the information read by the identification member to a database through the network device.

8. The brewing module according to claim 7, wherein the brewing control module checks the identification member on the package, and after the identification member is checked and confirmed to be a qualified identification member, the smart brewing machine will start the brewing operation of the brewing execution information, and each qualified identification member has a limit of times of starting the smart brewing machine to perform the brewing operation.

9. A brewing method of a brewing module, comprising:
obtaining a brewing material package unit;
sensing the brewing material package unit and a brewing control module;
obtaining related brewing information from the brewing material package unit by the brewing control module; and
sending the brewing information to a brewing machine control unit of a smart brewing machine via a cable or wireless transmission by the brewing control module.

10. The brewing method of a brewing module according to claim 9, wherein the brewing material package unit comprises a package and an identification member, and the package contains a brewing material, and after the brewing material is put into the smart brewing machine, the brewing machine control unit starts the brewing operation of the smart brewing machine.

11. The brewing method of a brewing module according to claim 10, further comprising: sending a part of the whole of the brewing information to a database via a cable or wireless transmission of a network device by the brewing control module.

12. The brewing method of a brewing module according to claim 11, further comprising: performing a statistical operation to analyze and summarize a part or the whole of the brewing information of the database and obtain brewing statistical information.

13. The brewing method of a brewing module according to claim 12, further comprising: the brewing statistical information is included into a big data operation and application.
